(19) United States
(12) Patent Application Publication
(10) Pub. No.: US 2006/0079190 A1
(43) Pub. Date: Apr. 13, 2006

(54) Data communication system with optimal damping function

(75) Inventors: Tomotake Ooba, Yamagata (JP); Yoichi Takahashi, Yamagata (JP); Fujio Higuchi, Yamagata (JP); Keiichi Iwazumi, Yamagata (JP); Akira Saitou, Yamagata (JP); Keiko Kobayashi, Yamagata (JP)

Correspondence Address: SUGHRUE MION, PLLC, 2100 PENNSYLVANIA AVENUE, N.W., SUITE 800, WASHINGTON, DC, 20037, US

(73) Assignee: NEC ELECTRONICS CORPORATION

(21) Appl. No.: 11/244,145

(22) Filed: Oct. 6, 2005

(30) Foreign Application Priority Data
Oct. 7, 2004 (JP) 295406/2004

(51) Int. Cl. H04B 17/00

(52) U.S. Cl. 455/226.1

(57) ABSTRACT

A data communication system includes a plurality of sensor initiators, each of which has first and second antennas; a communication control module and a plurality of sensor communication modules. The communication control module is connected with the plurality of sensor initiators through a LAN and is configured to control the plurality of sensor initiators such that a first electromagnetic wave signal for a command data signal is transmitted through the first antennas. Each of the plurality of sensor communication modules includes at least a sensor and third and fourth antennas. The sensor communication module is configured to receive the first electromagnetic wave signal for the command data signal by a resonance antenna as the third antenna to generate a reception voltage signal, to adjust a damping time of the reception voltage signal, and to transmit a measurement data signal obtained from the sensor to the communication control module from the fourth antenna by a second electromagnetic wave signal through the second antenna in response to the command data signal obtained from the reception voltage signal.

### BACKGROUND OF THE INVENTION

1. Field of the Invention

The present invention relates to a data communication system with an optimal damping function and a control method thereof.

2. Description of the Related Art

In recent years, safety-related regulations have been tightened in Japan and US. According to the TREAD Act (Transportation Recall Enhancement, Accountability and Document Act) that will come in effect in North America, a tire pneumatic pressure monitoring system should be installed to new cars to be on the market in 2006 and afterward. On that account, studies are currently being performed on a technique of attaching a sensor inside a tire and measuring a pneumatic pressure and temperature of the tire. In the technique, a sensor unit is installed in a valve portion of each of four tires to monitor all the four tires independently. This technique offers advantages in that it is possible to monitor the tire pneumatic pressure in a high precision even while the car is stopped or parked.

As a pneumatic pressure monitoring system, a system is known in which a tire pneumatic pressure is measured in a specific time interval, data on the tire pneumatic pressure is sent to a car body by radio wave, and the data is displayed on a display unit provided to a front panel of the car. This system is provided with a sensor communication module installed inside the tire wheel and a communication module attached to the car body. The sensor communication module is provided with several kinds of sensors for detecting a pneumatic pressure, temperature, etc., a receiving section for receiving a command data sent from the communication control module by LF (Low Frequency) wave, and a transmitting section for transmitting data obtained by the sensors to the receiving module by RF (Radio Frequency) wave. Electric power consumed in the transmitting module is all supplied from a battery connected to the transmitting module.

As stated above, the command data transmitted from the communication control module by the LF electromagnetic wave is transmitted in ASK (Amplitude Shift Keying) format. The sensor communication modules receive the LF electromagnetic wave of ASK data by an LC resonant antenna. Even after the LF electromagnetic wave is turned off, it will take a time until the voltage is converged at ends of the LC resonance antenna due to LC self-induced resonance. When the intensity of the received electromagnetic wave increases, the more time is required for this convergence. If a high voltage is induced between the ends of the LC resonance antenna, the voltage may not be converged within a period of time required for data communication. That is, it appears as if no time exists at which the electromagnetic wave is turned off and as if high data is continued at all times. In this case, it is necessary to decrease the transmission rate of data in order to transmit the next data after the convergence of the LC resonance, which causes a problem of increased communication time.

An example of a receiving module is disclosed in Japanese Laid Open Patent Application (JP-A-Heisei 10-68785) as a first conventional example. FIG. 1 shows a configuration of the receiving module provided with a coil 6003 of a resonance antenna and a receiving circuit 6001. The receiving circuit 6001 is provided with an initial stage amplifier 6009 which has resistances 6005, 6006, 6008, a capacitor 6007, and a transistor 6004, charge integration amplifiers which have amplifiers 6012, 6016, capacitors 6010, 6011, 6013, and 6015, and switches 6002 and 6014, a comparator circuit section 6019, a shift register circuit section 6021, a sampling and holding circuit section 6023, a 40 KHz clock 6017, a buffer circuit section 6028, an output control circuit section 6025, a detecting circuit section 6030.

In this conventional example, data recognition is carried out by sampling and holding the voltage generated on the wave receiving side at the same frequency as the carrier frequency on the transmitting side and detecting resultant changes. In this case, since the changes in the radio wave are detected, it is not necessary that the generated voltage be converged within a period of time required for data communication. According to this method, however, it is needed to activate an oscillator that generates the same frequency for sampling as the carrier frequency at all times during the data communication. This would increase the size of the circuit configuration and also the amount of power consumption.

### SUMMARY OF THE INVENTION

In an aspect of the present invention, a data communication device includes a resonance antenna configured to receive an electromagnetic wave signal for a data signal to generate a reception voltage signal; a damping section configured to damp the reception voltage signal based on a strength data indicative of a reception strength of the electromagnetic wave signal; and a demodulating and detecting section configured to reproduce the data signal from the damped reception voltage signal.

Here, the damping section may include a control section configured to control a damping time of the reception voltage signal based on the strength data.

In this case, the damping section may further include a damping circuit connected with the resonance antenna in parallel and having different resistances and switches respectively connected with the resistances. The control section turn on at least one of the switches based on the strength data to control the damping time. The damping circuit may further include a resistance fixedly connected with the resonance antenna in parallel.

Also, the data communication device may further include an interrupt circuit configured to issue an interrupt signal to the control section in response to the reception of the electromagnetic wave signal. The control section is set to an active state in response to the interrupt signal to start the control of the damping time. In this case, the demodulating and detecting section generates the strength data, and the control section controls the damping time of the reception voltage signal based on the strength data.

Also, when the damping time is initially set to a default time, and the electromagnetic wave signal has a preamble section of wave blocks and a data section containing the data signal, the control section adjusts the damping time based on the strength data for every wave block such that the damping time becomes an optimal damping time.

In another aspect of the present invention, a data communication system includes a plurality of sensor initiators, each of which has first and second antennas; a communication control module and a plurality of sensor communication modules. The communication control module is connected with the plurality of sensor initiators through a LAN and is configured to control the plurality of sensor initiators such that a first electromagnetic wave signal for a command data signal is transmitted through the first antennas. Each of the plurality of sensor communication modules includes at least a sensor and third and fourth antennas. The sensor communication module is configured to receive the first electromagnetic wave signal for the command data signal by a resonance antenna as the third antenna to generate a reception voltage signal, to adjust a damping time of the reception voltage signal, and to transmit a measurement data signal obtained from the sensor to the communication control module from the fourth antenna by a second electromagnetic wave signal through the second antenna in response to the command data signal obtained from the reception voltage signal.

Here, each of the plurality of sensor communication modules may include the resonance antenna as the third antenna configured to receive the first electromagnetic wave signal for the command data signal to generate the reception voltage signal; a damping circuit connected with the resonance antenna in parallel and configured to damp the reception voltage signal; a demodulating and detecting section configured to demodulate the damped reception voltage signal and to detect the command data signal from the demodulated reception voltage signal; a transmission section; and a control section configured to control the damping time of the reception voltage signal based on a reception strength of the first electromagnetic wave signal, and to control the transmission section in response to the command data signal such that the measurement data signal obtained from the sensor is transmitted to the communication control module from the fourth antenna by a second electromagnetic wave signal through the second antenna.

Also, the damping circuit includes different resistances and switches respectively connected with the resistances. The control section turns on at least one of the switches based on the strength data to control the damping time. In this case, the damping circuit may further include a resistance fixedly connected with the resonance antenna in parallel.

Also, the data communication system may further include an interrupt circuit configured to issue an interrupt signal to the control section in response to the reception of the first electromagnetic wave signal by the resonance antenna. The control section is set to an active state in response to the interrupt signal to start the control of the damping time. In this case, the demodulating and detecting section generates the strength data, and the control section controls the damping time of the reception voltage signal based on the strength data.

Also, when the damping time is initially set to a default time, and the first electromagnetic wave signal has a preamble section of wave blocks and a data section containing the command data signal, the control section adjusts the damping time based on the strength data for every wave block such that the damping time becomes an optimal damping time.

Also, the plurality of sensor communication modules are provided for tires, and the sensor is one of a tire pneumatic pressure sensor and a tire temperature sensor. Thus, the data communication system is a tire pressure monitoring system (TPMS).

In another aspect of the present invention, a method of communicating sensor data in a data communication system, may be achieved by transmitting a first electromagnetic wave signal for a command data signal sent from a communication control module to a plurality of sensor communication modules through first antennas; by receiving the first electromagnetic wave signal for the command data signal by a resonance antenna as a second antenna in each of the plurality of sensor communication modules to generate a reception voltage signal; by damping the reception voltage signal based on a reception strength of the first electromagnetic wave signal; by controlling a sensor section in response to the command data signal obtained from the reception voltage signal; by sensing at least one of a tire pneumatic pressure and a tire temperature by the sensor section to generate a measurement data signal; by transmitting the measurement data signal from the third antenna to a fourth antenna by a second electromagnetic wave signal; and by receiving the measurement data signal through the fourth antenna by the communication control module.

Here, the method may be achieved by further controlling a damping time of the reception voltage signal. In this case, the controlling a damping time may be achieved by selecting at least one of a plurality of resistances connected with the resonance antenna in parallel for the damping time of the reception voltage signal.

Also, the method may be achieved by further demodulating the reception voltage signal and detecting the command data signal from the demodulated reception voltage signal; by issuing an interrupt signal in response to the detected command data signal; and by activating the controlling in response to the command data signal. In this case, the method may be achieved by further adjusting the damping time based on the reception strength of the first electromagnetic wave signal prior to the detecting the command data signal.

### BRIEF DESCRIPTION OF THE DRAWINGS

FIG. 1 is a system block diagram showing a conventional receiving module;

FIG. 2 shows an outline structure of a TPMS (Tire Pressure Monitoring System) according to the embodiment of the present invention;

FIG. 3A is a block diagram showing the TPMS according to the embodiment of the present invention;

FIG. 3B is a block diagram of the TPMS according to the embodiment of the present invention;

FIG. 3C is a diagram showing wireless communication paths in the TPMS according to the embodiment of the present invention;

FIG. 4 is a block diagram showing an outline configuration of the sensor communication module of the present invention;

FIG. 5 is a diagram schematically showing a communication in the TPMS of the present invention;

FIGS. 6A to 6E are timing charts showing waveforms of a data, transmission output, reception voltage, comparator output and detection output in the TPMS of the present invention;

FIG. 7 is a diagram showing relationships between resistances in a damping resistance selecting circuit and the reception voltage;

FIG. 8 is a block diagram showing a detailed configuration of the sensor communication module provided with damping resistance selecting circuit according to this embodiment;

FIG. 9 is a block diagram showing a detailed configuration of a microcomputer provided in the sensor communication modules according to the embodiment of the present invention;

FIG. 10 is a diagram showing a radio wave format in a preamble period of reception electromagnetic wave received by the sensor communication module according to the embodiment of the present invention; and

FIG. 11 is a flowchart showing a selection operation of an optimal resistance within the preamble period by the sensor communication module provided with the damping resistance selecting circuit according to the embodiment of the present invention.

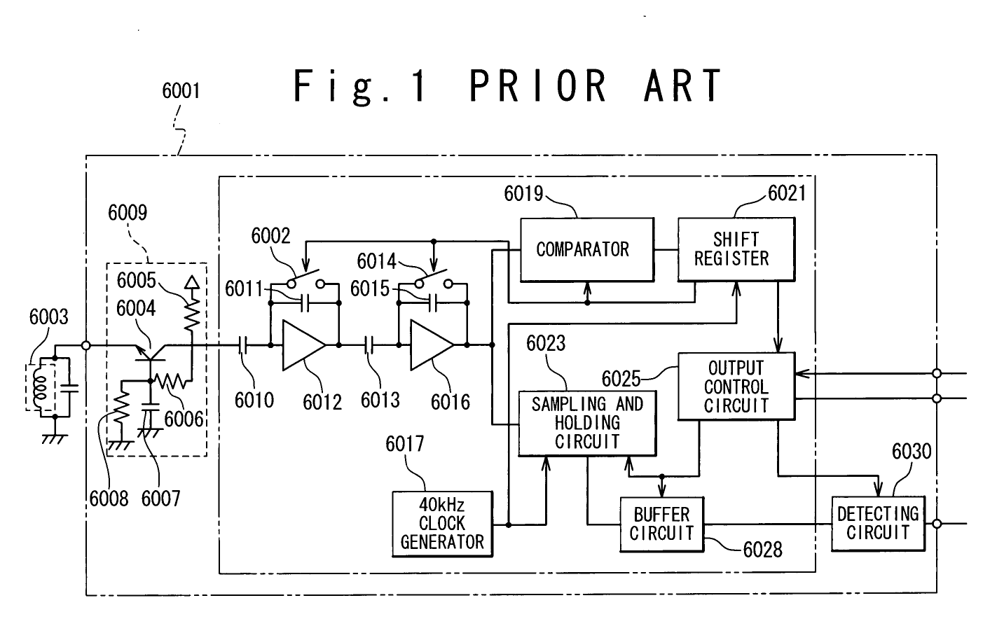

### DESCRIPTION OF THE PREFERRED EMBODIMENTS

Hereinafter, a data communication system with a damping resistance selecting circuit according to the present invention will be described in detail with reference to the attached drawings.

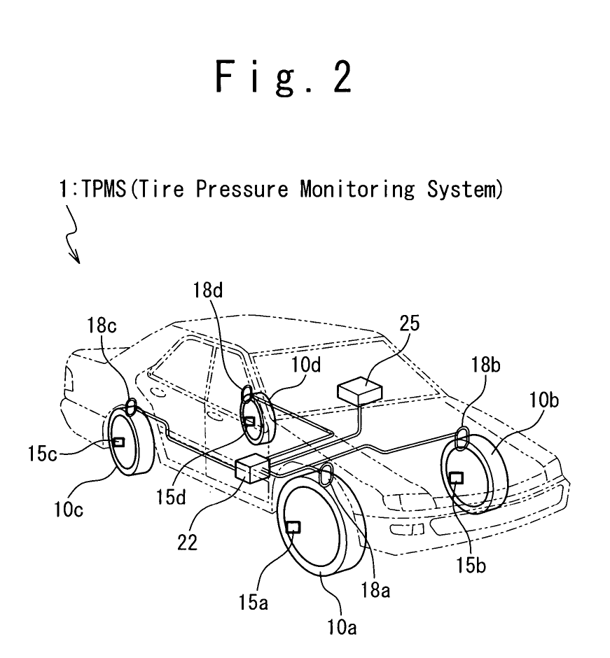

Firstly, FIG. 2 shows an outline configuration of a TPMS (Tire Pressure Monitoring System) 1 according to an embodiment of the present invention. The TPMS 1 is provided with sensor communication modules 15 (15a to 15d) attached inside wheels of four tires 10 (10a to 10d), sensor initiators 18 (18a to 18d), a communication control module 22 installed on a car body, and a display unit 25. The communication control module 22, the sensor initiator 18, and the display unit 25 are connected by an in-car LAN. The sensor initiator 18 is provided with an LF (low frequency) antenna 23 and an RF (radio frequency) antenna 24, which will be described later. The communication control module 22 has not only a function of receiving RF (radio frequency) electromagnetic wave transmitted from a Key Less Entry unit (not shown), etc, and transmitting a command data signal to the sensor communication modules 15, but also a function of receiving data signals transmitted from the sensor communication modules 15. The command data signal indicates each of various commands. Each of the sensor communication modules 15 includes several kinds of sensors for detecting a tire pneumatic pressures, a tire temperatures, etc., receives the command data signal transmitted from the communication control module 22 through LF (low frequency) antenna 23 by LF (low frequency) electromagnetic wave, and transmits the data signal obtained from the sensors to the communication control module 22 through the RF antenna 24 by RF electromagnetic wave. The sensor communication modules 15 of the TPMS 1 according to this embodiment are basically provided for all the four tires 10, respectively. Each of the sensor communication modules 15 has a same configuration.

When a driver gets into a car, the RF electromagnetic wave for Key Less Entry is transmitted to the communication control module 22. Upon receiving the RF electromagnetic wave for Key Less Entry, the communication control module 22 transmits the command data signal to the sensor communication modules 15 through an in-car LAN and the LF antennas 23 of the sensor initiators 18 by LF electromagnetic wave (125 KHz) to notify start of the car. In response to the command data signal, the sensor communication modules 15 are activated such that the sensors measure pneumatic pressures and temperatures of the tires 10. Then, the measured data are transmitted as measurement data signals from the sensor communication modules 15 to the communication control module 22 through the RF antennas 24 of the sensor initiators 18 by the RF electromagnetic wave (433 MHz or 315 MHz). The communication control module 22 drives the display unit 25 to display the measurement data signals.

When the car starts running, motion switches (not shown) provided for the tires sense the running of the car. At this time, when the tire pneumatic pressure has reached a predetermined value, or in a specific time interval, the sensor communication modules 15 transmit the measurement data signals to the communication control module 22 by RF electromagnetic wave. Then, the communication control module 22 transmits the measurement data signals to the display unit 25 and a warning section (not shown). The display unit 25 and the warning section notify the pneumatic pressure and temperature etc of the tires to the driver.

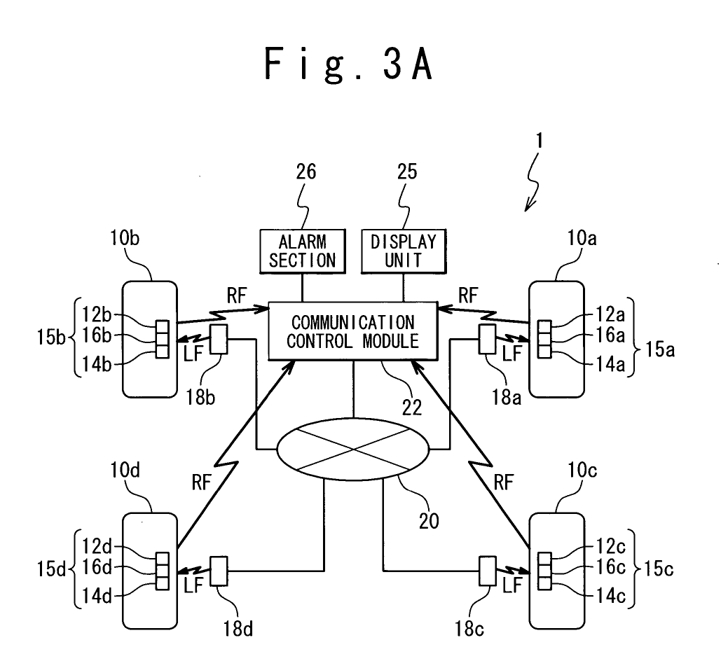

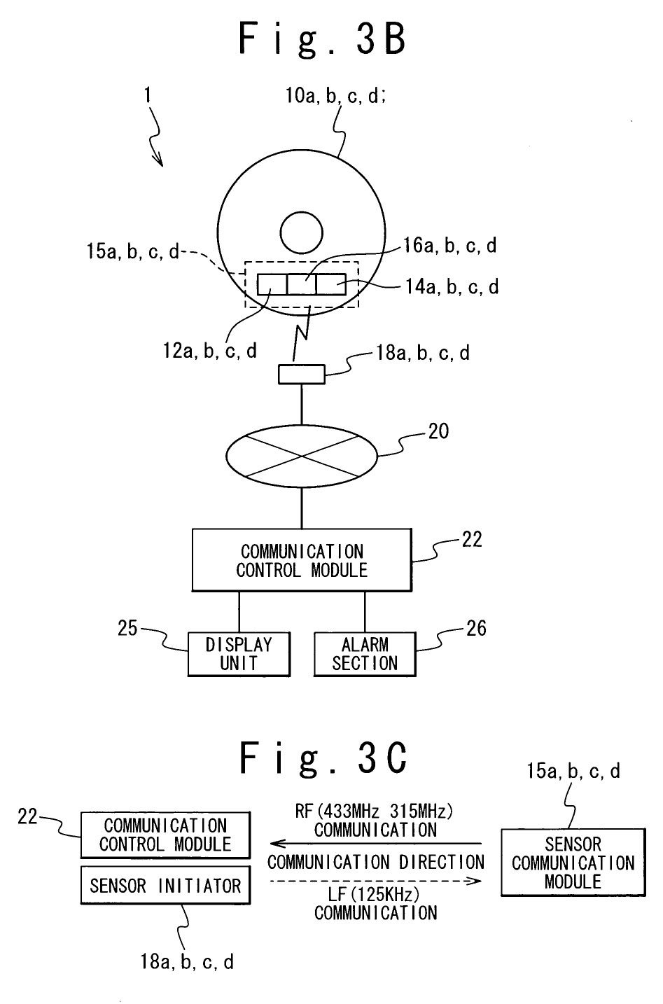

FIGS. 3A and 3B are system block diagrams showing the TPMS 1 according to the embodiment of the present invention. Also, FIG. 3C shows wireless communication paths in the TPMS 1 according to the embodiment of the present invention.

The sensor communication modules 15 of the TPMS 1 according to the embodiment of the present invention are attached to all the tires 10, respectively. The sensor communication module 15 includes a pneumatic pressure sensor 12 (12a to 12d), a temperature sensor 14 (14a to 14d), and a transmitting section 16 (16a to 16d) for transmitting measurement data signal obtained from the sensors 12 and 14 to the communication control module 22 by RF electromagnetic wave.

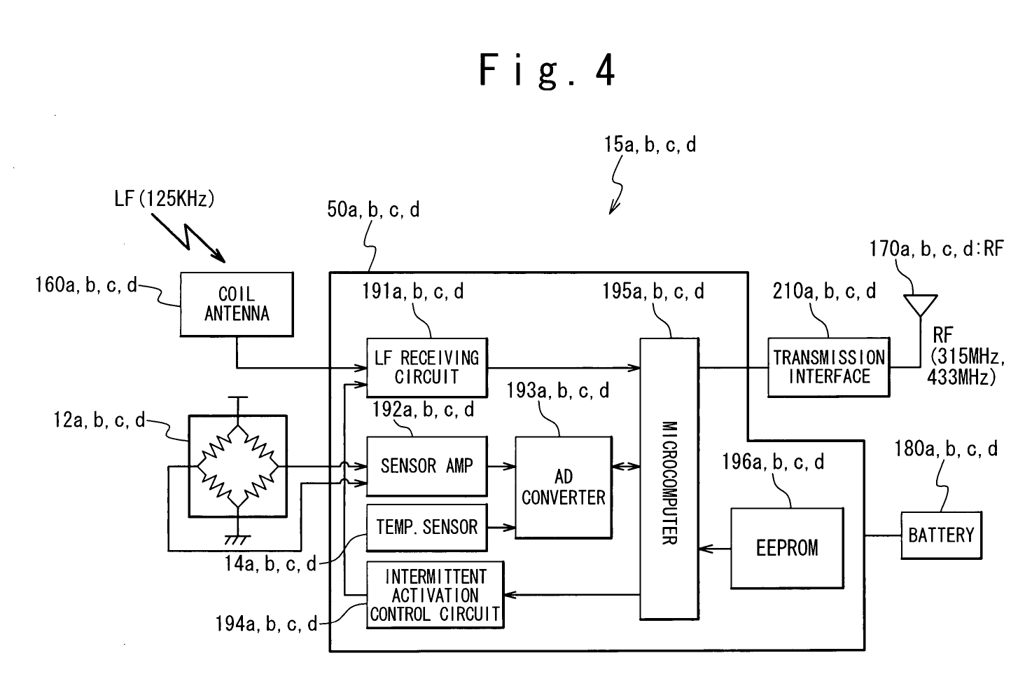

FIG. 4 is a block diagram schematically showing the sensor communication module 15. As shown in FIG. 4, the sensor communication module 15 is provided with a coil antenna 160 (160a to 160d), the tire pneumatic pressure sensor 12 (12a to 12d), a transmission interface 210 (210a to 210d) as the transmitting section, an RF antenna 170 (170a to 170d), and a battery 180 (180a to 180d). The sensor communication module 15 is further provided with an LF receiving circuit 191 (191a to 191d), a sensor amplifier (AMP) 192 (192a to 192d), the tire temperature sensor 14 (14a to 14d), an intermittent activation control circuit 194 (194a to 194d), an AD converter 193 (193a to 193d), a microcomputer 195 (195a to 195d), and an EEPROM 196 (196a to 196d).

The intermittent control circuit 194 intermittently transmits an activation signal to the LF receiving circuit 191 to activate the LF receiving circuit 191. The LF receiving circuit 191 receives the LF electromagnetic wave of a command data signal transmitted from the communication control module 22 through the coil antenna 160 in the active state and notifies the reception of the command data signal to the microcomputer 195. The microcomputer 195 carries out a process corresponding to a command of the command data signal. When the command indicates measurement by the sensors, the microcomputer 195 controls each section of the sensor communication module 15. Thus, the sensor amplifier 192 amplifies an analog pneumatic pressure measurement data signal outputted from the tire pneumatic pressure sensor 12 to output to the AD converter 193. The AD converter 193 converts the analog pneumatic pressure measurement data signal and an analog temperature measurement data signal into digital measurement data signals. The EEPROM 196 stores identification (ID) data of the tire indicative of the tire position and various kinds of correction data. The microcomputer 195 transmits the digital measurement data signals to the communication control module 22 through the transmission interface 210 and the RF antenna 170 by the RF electromagnetic wave. The battery 180 supplies the electric power to the communication device 50 and the transmission interface 210.

In the conventional transmission module, an activating circuit is always active. The activating circuit receives the LF electromagnetic wave of command data signal and sends an interrupt signal to the microcomputer. When the conventional transmission module has received the LF electromagnetic wave of command data signal, the microcomputer acquires data measured by the sensors. Electric power to be consumed by the conventional transmission module is all supplied from the battery connected to the conventional transmission module. However, in order to operate the conventional transmission module for a long time without replacing the battery, an amount of power consumed for making the activating circuit active all the times cannot be ignored.

The sensor communication module 15 according to the present invention includes an intermittent activation control circuit 194 (194a to 194d), instead of the activating circuit.

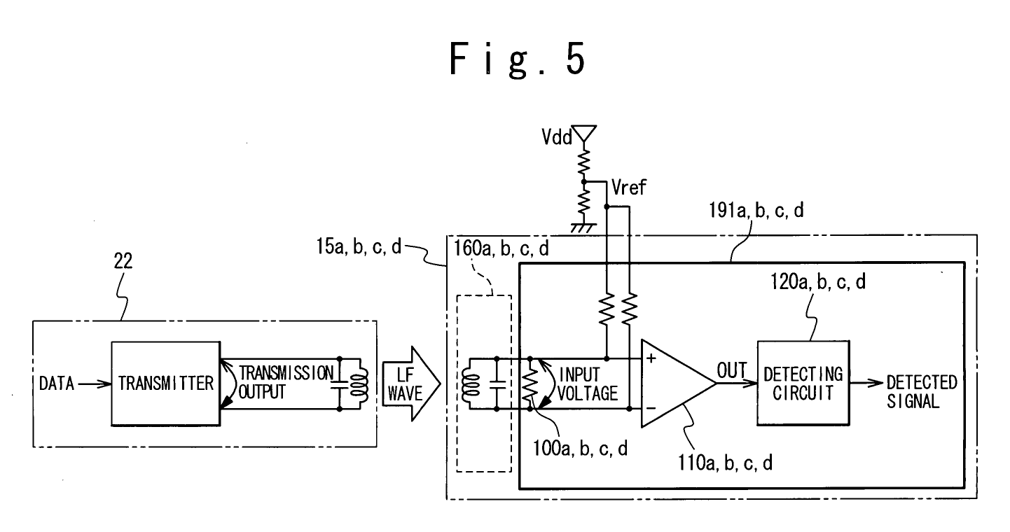

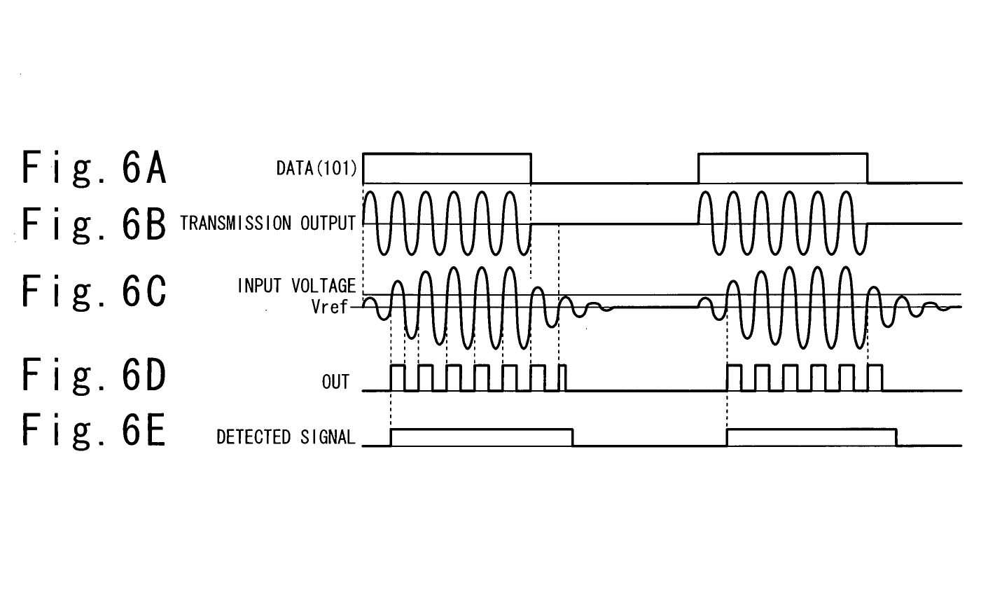

FIG. 5 is a circuit diagram schematically showing the configuration of a part of the data communication system. FIGS. 6A to 6E show waveforms when a command data signal in an ASK (amplitude shift Key) format transmitted from the communication control module 22 by the LF electromagnetic wave through the in-car LAN 20 and the sensor initiator 18 is received by the sensor communication module 15. FIGS. 6A to 6E shows a case that the communication control module 22 transmits a command data signal of “101” in the ASK format. The same can be applied to the case of other data arrays.

As shown in FIG. 5, the LF electromagnetic wave to be transmitted from the communication control module 22 to the sensor communication modules 15 though the in-car LAN 20 and the sensor initiators 18 is received by a LC resonant coil antenna 160 (160a to 160d) provided for the sensor communication module 15, as shown in FIGS. 6A and 6B. When the coil antenna 160 receive the LF electromagnetic wave, a sinusoidal reception voltage signal is generated across the both ends of a damping resistor 100 (100a to 100d) connected to the coil antenna 160 in parallel, as shown in FIG. 6C. The sinusoidal reception voltage signal corresponding to the command data signal is supplied to a comparator 110 (110a to 110d) connected to the damping resistor 100. The sinusoidal reception voltage signal corresponding to the command data signal is converted into a rectangular waveform signal, as shown in FIG. 6D. The rectangular waveform signal is supplied into a detector 120 (120a to 120d) connected to the comparator 110, and then returned to a transmission output waveform of the command data signal in the ASK format, as shown in FIG. 6E. Then, the reproduced command data signal demodulated into the ASK format is supplied to the microcomputer 195 connected to the detector 120.

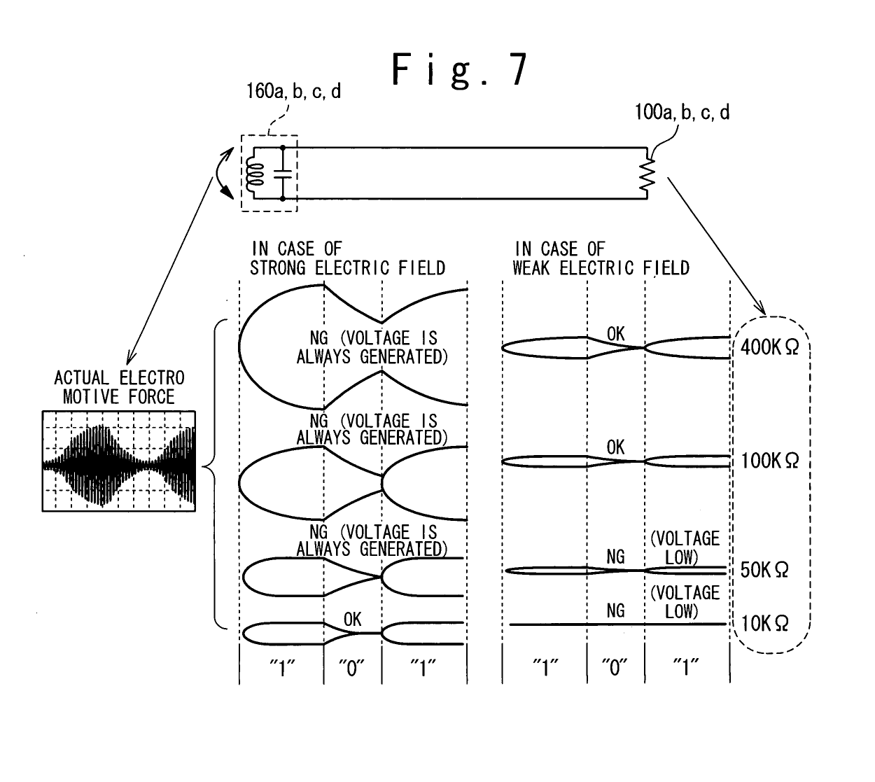

FIG. 7 shows the coil antenna 160 and the damping resistor 100 in the sensor communication module 15 shown in FIG. 5. In FIG. 7, shown is the sinusoidal reception voltage signal generated across the both ends of the damping resistor 100 when the damping resistor 100 is changed.

When the intensity of LF electromagnetic wave transmitted from the communication control module 22 through the in-car LAN 20 and the sensor initiator 18 is strong, and the damping resistor 100 is set to 400 KΩ as a default value (most highly sensitive value), the reception voltage signal remains without decrease to “0”s even in the time domain corresponding to the value “0” of the data in which no reception voltage signal is generated. This may cause a data reading error. The same occurs in case that the damping resistor 100 is set to 100 KΩ or 50 KΩ. Only if the damping resistor 100 is set to 10 KΩ, the reception voltage signal is reproduced corresponding to “1” or “0” of the data. Therefore, it is necessary here to set the damping resistor 100 to 10 KΩ.

On the other hand, if the intensity of the LF electromagnetic wave transmitted from the communication control module 22 is weak, and the damping resistor 100 is set to 400 KΩ as the most highly sensitive value, the reception voltage signal corresponding to “1” or “0” of the data can be reproduced. The same occurs in case where the damping resistor 100 is set to 100 KΩ. If the damping resistor 100 is set to 50 KΩ or 10 KΩ, the reception voltage signal remains small. In this case, the reception voltage signal corresponding to “1” or “0” of the data is not reproduced but the reception voltage signal corresponding to “0” is always reproduced. Therefore, in this case, it is needed here to set the damping resistor 100 to 400 KΩ or 100 KΩ.

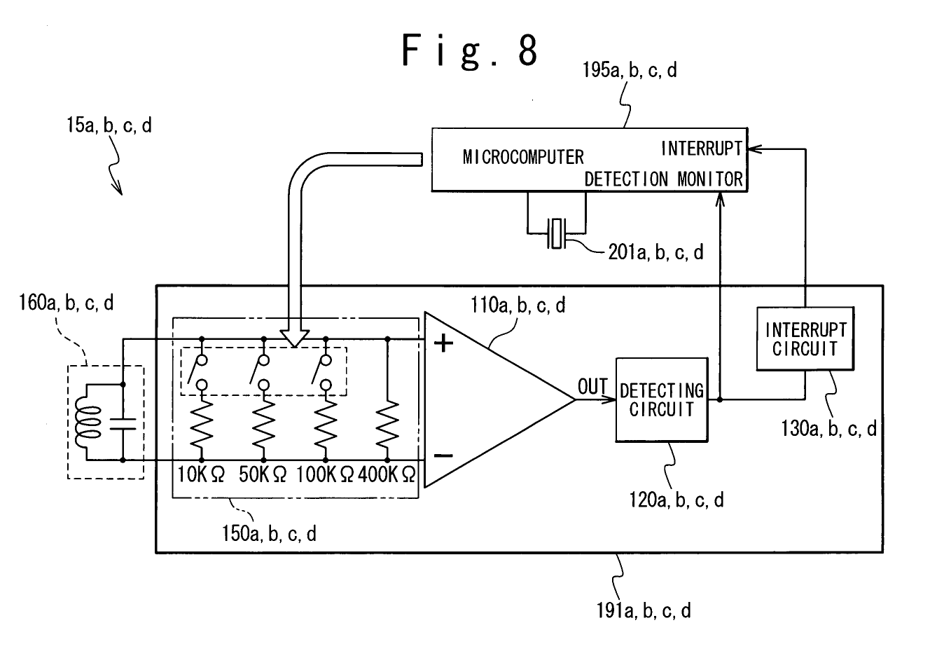

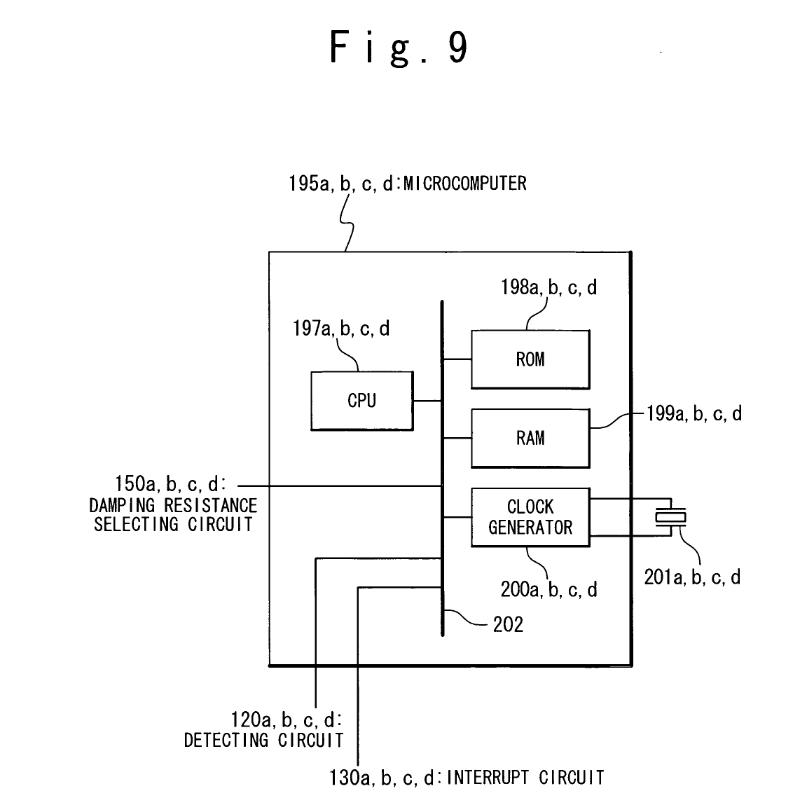

FIG. 8 shows a system block diagram of the sensor communication module 15 provided with a damping resistance selecting circuits 150 (150a to 150b) according to this embodiment. The sensor communication module 15 provided with the damping resistance selecting circuit 150 according to this embodiment includes the coil antennas 160 for receiving LF electromagnetic wave transmitted from the communication control module 22 through the in-car LAN 20 and the sensor initiator 18, the damping resistance selecting circuit 150 connected to the coil antenna 160, the comparator 110 connected to the damping resistance selecting circuit 150, the detector 120 connected to the comparator 110, and an interrupt circuit 130 (130a to 130d) connected to the detection 120, and the microcomputer 195 connected to the detector 120. The damping resistance selecting circuit 150 according to this embodiment has a plurality of resistors that have resistances such as 400 KΩ, 100 KΩ, 50 KΩ and 10 KΩ. Each of the resistors of 100 KΩ, 50 KΩ and 10 KΩ is connected with a switch such as a MOS transistor in series. The resistor of 400 KΩ is not provided with any switch. However, a switch may be also provided for the resistor of 400 KΩ. The resistors of the damping resistance selecting circuit 150 according to this embodiment are provided for the coil antenna 160 in parallel. In this circuit, an optimal resistance value is selected in response to a control signal from the microcomputer 195. In the damping resistance selecting circuit 150 according to this embodiment, the resistance value of 400 KΩ is selected as a default value in activation of the sensor communication module 15. Also, as shown in FIG. 9, the microcomputer 195 includes a CPU 197, a ROM 198 (198a to 198d) connected to the CPU 197 through a bus line 202 (202a to 202d), respectively, RAMs 199a to 199d, and clock generators 200a to 200d. The clock generator 200 (200a to 200d) has an oscillator 201 (201a to 201d).

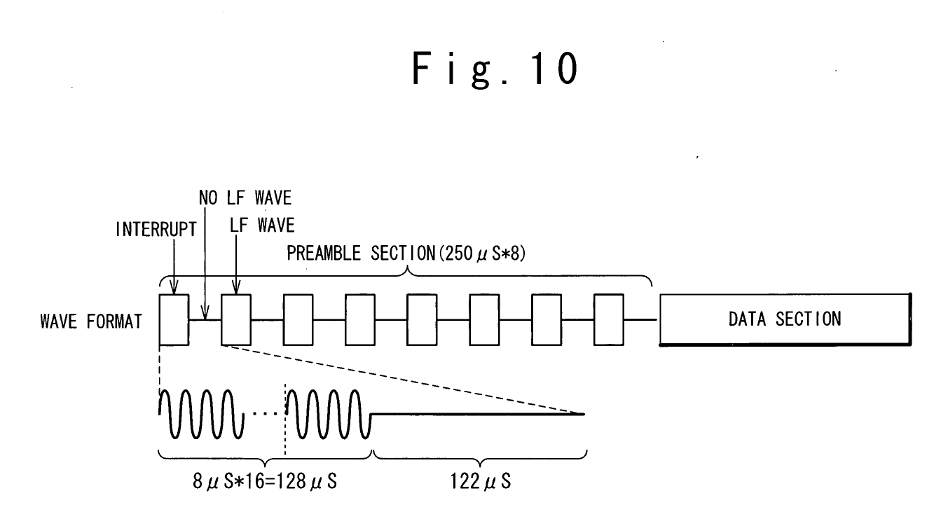

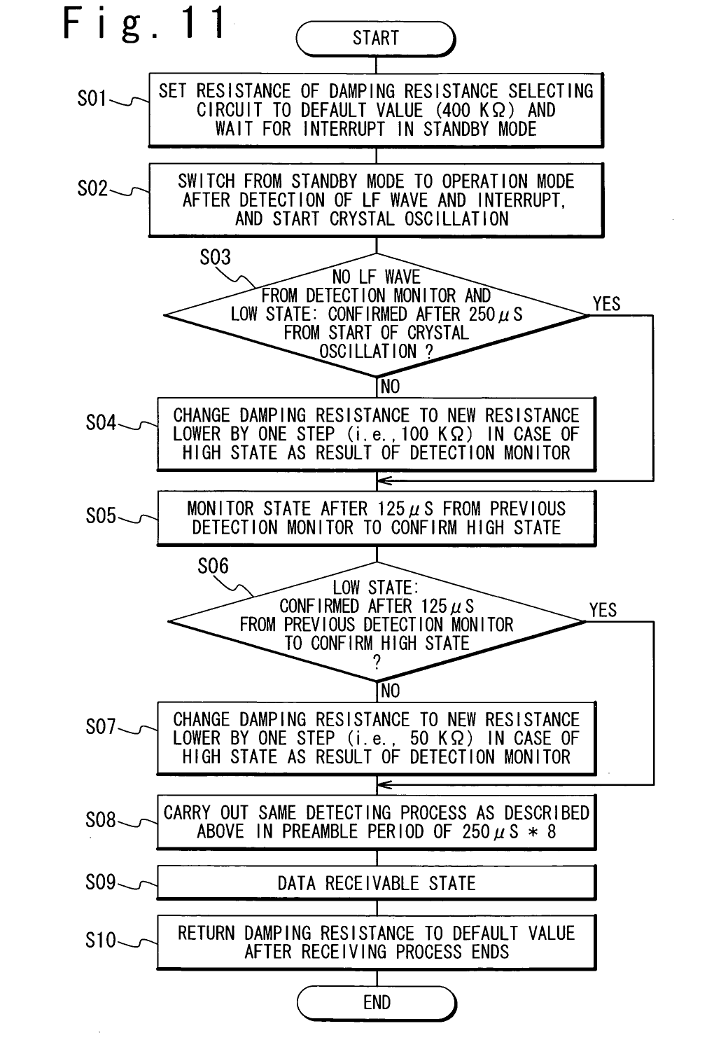

Next, an operation of the sensor communication modules 15 with the damping resistance selecting circuits 150 according to this embodiment will be described below with reference to FIG. 10. FIG. 10 shows the LF electromagnetic wave. The LF electromagnetic wave has a preamble section and a data section in which the command data signal is written. The preamble section has eight sub-sections of 250 μS. Each of the eight sub-sections has a first section (block) of 128 μS (=8 μS*16 cycles) in which the LF electromagnetic wave is present to indicate “1” and a halt section of 122 μS in which the LF electromagnetic wave is absent to indicate “0”. The optimal resistance value is selected in the damping resistance selecting circuit 150 within the preamble period of 250*8 μS. The communication control module 22 transmits a command data signal in the ASK format through the in-car LAN 20 and the sensor initiator 18 to the sensor communication modules 15 attached to the tires by LF electromagnetic wave. When the coil antenna 160 of the sensor communication module 15 receives the LF electromagnetic wave, the reception voltage signal is generated across the both ends of the coil antenna 160. In the damping resistance selecting circuit 150 according to this embodiment, the optimal resistance value is selected in response to the control signal from the microcomputer 195 in accordance with the intensity of the LF electromagnetic wave supplied to the coil antenna 160. Then, the command data signal of the reception voltage is adjusted to be optimal in the damping resistance selecting circuit 150 and is supplied to the microcomputer 195 through the comparator 120 and the detector 120.

FIG. 11 shows a flowchart for selecting the optimal resistance value in the damping resistance selecting circuit 150 of this embodiment. The selection of the optimal resistance value is carried out within a preamble section after an interrupt signal is supplied from interrupt circuit 130 (130a to 130d) to the microcomputer 195. The resistance value in the damping resistance selecting circuit 150 is set to 400 KΩ (most highly sensitive state) as the default value, until the interrupt signal is supplied to the microcomputer 195, and the interrupt signal is waited for in a stand-by mode of the microcomputer 195 (Step S01). When the LF electromagnetic wave of the command data signal is transmitted from the communication control module 22 and received by the coil antenna 160 of the sensor communication module 15, the LF electromagnetic wave of the first sub-section is supplied to the interrupt circuit 130 through the comparator 110 and the detector 120 and the interrupt signal is outputted from the interrupt circuit 130 to the microcomputer 195. The CPU 197 provided in the microcomputer 195 is activated in response to the interrupt signal, and the microcomputer 195 is switched from the stand-by mode to the active mode. When the microcomputer 195 is in the active mode, the crystal oscillator 201 provided in the microcomputer 195 starts oscillation to generate an oscillation signal (S02). After 125 μS since the crystal oscillator 201 starts the oscillation, it is confirmed whether the output from the detector 120 is “LOW” or not, namely, whether there is no LF electromagnetic wave (S03). If it is confirmed that the output from the detector 120 is “LOW”, the damping resistor value is remained as it is. If the output from the detector 120 is “HIGH”, the resistance value of the damping resistance selecting circuit 150 is set to 100 KΩ, by decreasing sensitivity by one level, under control by the microcomputer 195 (S04). Then, the detector 120 carries out the detection of the LF electromagnetic wave after 125 μS from the previous detection to confirm that the output from the detector 120 is “HIGH” (S05). Furthermore, the detector 120 carries out the detection of the LF electromagnetic wave after 125 μS from the previous detection to confirm whether the output from the detector 120 is “LOW” or not (S06). If it is confirmed that the output from the detector 120 is “LOW”, the damping resistance value is remained as it is. If it is confirmed that the output from the detector 120 is “HIGH”, the resistance value of the damping resistance selecting circuit 150 is set to 50 KΩ, further lower in sensitivity by one level, under control from the microcomputer 195 (S07). The same detection process is carried out within the preamble period of 250 μS*8 sub-sections (S08). Upon completion of the above mentioned process, the setting of the optimal resistance value in the damping resistance selecting circuit 150 of the sensor communication module 15 is terminated, and the sensor communication module 15 is ready for reception of the command data signal in the data section (S09). When a series of reception processes is completely finished, the resistance value of the damping resistance selecting circuit 150 is returned to the default of 400 KΩ by section of control signal from the microcomputer 195 (S10).

In this embodiment, the damping resistance selecting circuit 150 has four kinds of damping resistor values of 400 KΩ, 100 KΩ, 50 KΩ and 10 KΩ. However, the present invention is not limited to this. The number of resistance values and the optimal combination are selected in accordance with the intensity of LF electromagnetic wave transmitted from the communication control module 22 and the distance between the communication control module 22 and the sensor communication module 15. Additionally, if the intensity of LF electromagnetic wave transmitted from the communication control module 22 and the distance between the communication control module 22 and each of the sensor communication modules 15 are maintained constant, it is not necessary to re-set the resistance value of the damping resistance selecting circuit 150 each time when the CPU is activated. In this case, the optimal resistance value of the damping resistance selecting circuit 150 may be set only when the communication control module 22 transmits the command data signal to instruct the sensor communication modules 15 to re-set the damping resistance value.

In the sensor communication module 15 with the damping resistance selecting circuit 150 according to this embodiment, the optimal resistance value is selected in the damping resistance selecting circuit 150 in accordance with the intensity of LF electromagnetic wave transmitted from the communication control module 22 to the coil antenna 160 of the sensor communication module 15 through the in-car LAN 20 and the sensor initiator 18. Thus, it is possible to always provide stable communication between the sensor communication module 15 with the damping resistance selecting circuit 150 according to this embodiment and the communication control module (radio source) arranged within a specific communication distance range.

As compared with the conventional method of data identification through sampling and holding, the present invention does not require the oscillator to be activated for accurate sampling, thereby achieving communications with low power consumption. Moreover, it is conventionally needed to wait for the convergence of reception voltage resulting from LF electromagnetic wave transmitted from the communication control module, which leads to decrease in the rate of data reception. However, in case of data identification not depending on the conventional sampling and holding method, the rate of reception does not require to be decreased, like the present invention.

In the present invention, a TPMS for tires attached to a car is mainly described. As a matter of course, the present invention is not limited to a car. This embodiment is applicable to apparatuses that carry out communications by section of radio electromagnetic wave and has a communication protocol including a data portion and a preamble portion.

Also, needless to say, the data communication method according to this embodiment is applicable as a more power-saving communication technique in general data communications in ASK mode.

What is claimed is:

1. A data communication device comprising:
a resonance antenna configured to receive an electromagnetic wave signal for a data signal to generate a reception voltage signal;
a damping section configured to damp said reception voltage signal based on a strength data indicative of a reception strength of the electromagnetic wave signal; and
a demodulating and detecting section configured to reproduce said data signal from the damped reception voltage signal.

2. The data communication device according to claim 1, wherein said damping section comprises:
a control section configured to control a damping time of said reception voltage signal based on the strength data.

3. The data communication device according to claim 2, wherein said damping section further comprises:
a damping circuit connected with said resonance antenna in parallel and having different resistances and switches respectively connected with the resistances, and
said control section turn on at least one of said switches based on the strength data to control the damping time.

4. The data communication device according to claim 3, wherein said damping circuit further comprises a resistance fixedly connected with said resonance antenna in parallel.

5. The data communication device according to claim 2, further comprising:
an interrupt circuit configured to issue an interrupt signal to said control section in response to the reception of said electromagnetic wave signal,
wherein said control section is set to an active state in response to the interrupt signal to start the control of the damping time.

6. The data communication device according to claim 5, wherein said demodulating and detecting section generates the strength data, and
said control section controls the damping time of said reception voltage signal based on the strength data.

7. The data communication device according to claim 2, wherein the damping time is initially set to a default time,
said electromagnetic wave signal has a preamble section of wave blocks and a data section containing said data signal, and
said control section adjusts the damping time based on the strength data for every wave block such that the damping time becomes an optimal damping time.

8. A data communication system comprising:
a plurality of sensor initiators, each of which has first and second antennas;
a communication control module connected with said plurality of sensor initiators through a LAN and configured to control said plurality of sensor initiators such that a first electromagnetic wave signal for a command data signal is transmitted through said first antennas; and
a plurality of sensor communication modules, each of which comprises at least a sensor and third and fourth antennas, and configured to receive said first electromagnetic wave signal for said command data signal by a resonance antenna as said third antenna to generate a reception voltage signal, to adjust a damping time of said reception voltage signal, and to transmit a measurement data signal obtained from said sensor to said communication control module from said fourth antenna by a second electromagnetic wave signal through said second antenna in response to said command data signal obtained from said reception voltage signal.

9. The data communication system according to claim 8, wherein each of said plurality of sensor communication modules comprises:
said resonance antenna as said third antenna configured to receive said first electromagnetic wave signal for said command data signal to generate said reception voltage signal;
a damping circuit connected with said resonance antenna in parallel and configured to damp said reception voltage signal;
a demodulating and detecting section configured to demodulate the damped reception voltage signal and to detect said command data signal from the demodulated reception voltage signal;
a transmission section; and
a control section configured to control the damping time of said reception voltage signal based on a reception strength of said first electromagnetic wave signal, and to control said transmission section in response to said command data signal such that the measurement data signal obtained from said sensor is transmitted to said communication control module from said fourth antenna by a second electromagnetic wave signal through said second antenna.

10. The data communication system according to claim 9, wherein said damping circuit comprises different resistances and switches respectively connected with the resistances, and
said control section turns on at least one of said switches based on the strength data to control the damping time.

11. The data communication system according to claim 10, wherein said damping circuit further comprises a resistance fixedly connected with said resonance antenna in parallel.

12. The data communication system according to claim 9, further comprising:
an interrupt circuit configured to issue an interrupt signal to said control section in response to the reception of said first electromagnetic wave signal by said resonance antenna,
wherein said control section is set to an active state in response to the interrupt signal to start the control of the damping time.

13. The data communication system according to claim 12, wherein said demodulating and detecting section generates the strength data, and
said control section controls the damping time of said reception voltage signal based on the strength data.

14. The data communication system according to claim 9, wherein the damping time is initially set to a default time,
said first electromagnetic wave signal has a preamble section of wave blocks and a data section containing said command data signal, and
said control section adjusts the damping time based on the strength data for every wave block such that the damping time becomes an optimal damping time.

15. The data communication system according to claim 8, wherein said plurality of sensor communication modules are provided for tires,
said sensor is one of a tire pneumatic pressure sensor and a tire temperature sensor, and
said data communication system is a tire pressure monitoring system (TPMS).

16. A method of communicating sensor data in a data communication system, comprising:
transmitting a first electromagnetic wave signal for a command data signal sent from a communication control module to a plurality of sensor communication modules through first antennas;
receiving said first electromagnetic wave signal for said command data signal by a resonance antenna as a second antenna in each of said plurality of sensor communication modules to generate a reception voltage signal;
damping said reception voltage signal based on a reception strength of said first electromagnetic wave signal;
controlling a sensor section in response to said command data signal obtained from said reception voltage signal;
sensing at least one of a tire pneumatic pressure and a tire temperature by said sensor section to generate a measurement data signal;
transmitting said measurement data signal from said third antenna to a fourth antenna by a second electromagnetic wave signal; and
receiving said measurement data signal through said fourth antenna by said communication control module.

17. The method according to claim 16, further comprising:
controlling a damping time of said reception voltage signal.

18. The method according to claim 17, wherein said controlling a damping time comprises:
selecting at least one of a plurality of resistances connected with said resonance antenna in parallel for said damping time of said reception voltage signal.

19. The method according to claim 17, further comprising:
demodulating said reception voltage signal and detecting said command data signal from the demodulated reception voltage signal;
issuing an interrupt signal in response to the detected command data signal; and
activating said controlling in response to said command data signal.

20. The method according to claim 19, further comprising:
adjusting said damping time based on the reception strength of said first electromagnetic wave signal prior to said detecting said command data signal.
